(19) United States
(12) Patent Application Publication
(10) Pub. No.: US 2025/0381533 A1
(43) Pub. Date: Dec. 18, 2025

(54) Actuator For A Dual Pump Dispensing System

(71) Applicant: ELC Management LLC, Melville, NY (US)

(72) Inventors: Chuzhen Que, Minghang District, Shanghai (CN); Yun Chen, Changning District, Shanghai (CN); Jing Jin, Pudong District, Shanghai (CN)

(21) Appl. No.: 18/705,505

(22) PCT Filed: Nov. 8, 2021
(86) PCT No.: PCT/CN2021/129275

§ 371 Date: Apr. 26, 2024

(51) Int. Cl. B01F 25/434; B01F 23/40; B01F 25/452

(52) U.S. Cl. CPC B01F 25/4341; B01F 25/4523; B01F 23/48

(57) ABSTRACT

An actuating mechanism for a dual pump dispensing system comprises an actuator housing, a semi-spiral insert and optionally, a mesh screen (3). The actuating mechanism is intended to mix viscous products that flow under the forces achieved in mechanical pump dispensers of the types used in the cosmetic and personal care fields.

### FIELD OF THE INVENTION

The present invention is in the field of dispensing systems for personal care products. More specifically, the invention pertains to systems that comprise two mechanical pump dispensers for simultaneously dispensing two products.

### BACKGROUND OF THE INVENTION

Cosmetic and personal care dispensing systems that simultaneously dispense two different products from separate product reservoirs are known. Such systems may use two mechanical pump dispensers (one for each reservoir), or one mechanical pump dispenser that draws products from both reservoirs. In either case, there is typically only one actuating mechanism. In the case of two mechanical pump dispensers, the two products may not be mixed until they are deposited onto an application surface, such as the skin. This type of system may be preferred when the two products are reactive with each other, but should be prevented from reacting until the time of use. Alternatively, the two products may be allowed to mix with each other as they pass through an actuating mechanism.

### OBJECTIVE

A main objective of the present invention is to provide an actuating mechanism that thoroughly mixes two products as they pass through the actuating mechanism.

Another objective of the present invention is to provide an actuating mechanism for a dual pump dispensing system that thoroughly mixes two products as they are dispensed by the dual pump dispensing system.

### DESCRIPTION OF THE FIGURES

FIG. 1 depicts an actuator mechanism according to the present invention.

FIG. 2 is a cross sectional elevation view of an actuator housing.

FIG. 3 is a cross sectional perspective view of an actuator housing.

FIG. 4 is a side elevation view of a semi-spiral insert according to the present invention.

FIG. 5 is a cross sectional view of the semi-spiral insert of FIG. 4.

FIG. 6 is a top view of a semi-spiral insert according to the present invention.

FIG. 7 is a bottom perspective view of the semi-spiral insert of FIG. 6, and mesh screen.

FIG. 8 is a cross sectional elevation view of an assembled actuating mechanism secured to the stems of a dual pump mechanism

### SUMMARY

According to the present invention, an actuating mechanism for a dual pump dispensing system comprises an actuator housing (1), a semi-spiral insert (2) and optionally, a mesh screen (3). The actuating mechanism is intended to mix viscous products that flow under the forces achieved in mechanical pump dispensers of the types used in the cosmetic and personal care fields. Viscous products, include creams, lotions and serums of the type common in the cosmetic and personal care fields.

### DETAILED DESCRIPTION

### Actuator Housing

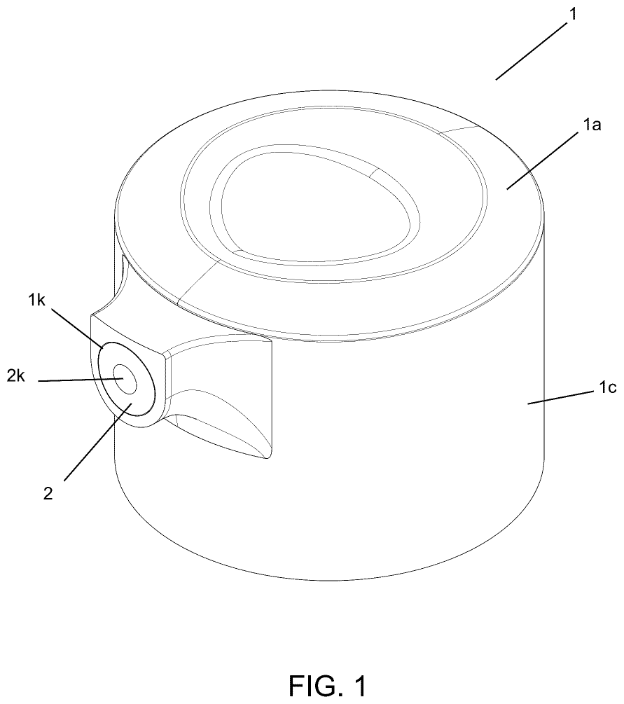

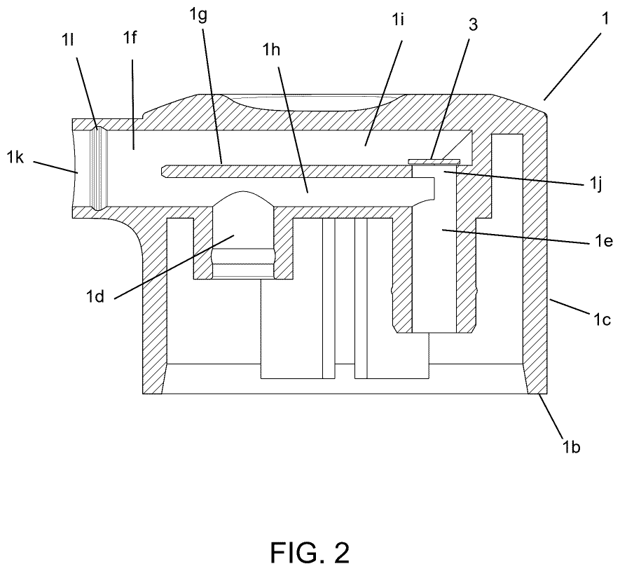

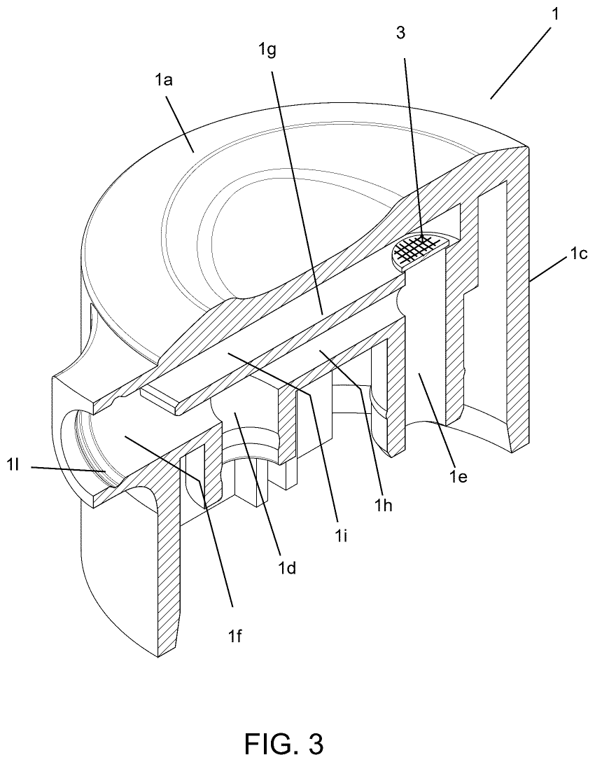

Referring to FIGS. 1-3, the actuator housing (1) comprises a top (1a), an opened bottom (1b) and a skirt wall (1c). The top may typically serve as the surface that receives finger pressure to actuate a dual pump mechanism to which the actuator housing is attached. The skirt wall surrounds a first inlet channel (1d) that is able to receive a first product from a first product reservoir, and a second inlet channel (1e) that is able to receive a second product from a second product reservoir. A flow path is provided for conducting the first and second products from the first and second inlet channels to a semi-spiral insert (see below), and eventually out of an outlet (1k) that opens up to the outside of the actuator housing. The flow path may be divided into an lower flow path and an upper flow path. For example, the actuator housing may comprise a barrel (1f). The barrel will typically be cylindrical, and comprise a front and rear. The barrel is divided longitudinally by a partition (1g), into a lower flow path (1h) and an upper flow path (1i). The first and second inlet channels open up into the lower flow path of the barrel. Toward the rear of the barrel, the lower flow path is connected to (or communicates with) the upper flow path through duct (1j). The front of the barrel terminates at the outlet (1k) that opens up to the outside of the actuator housing. Optionally, a snap fit feature, such an annular groove (1l) may be formed in the wall of the barrel, near the outlet (1k) of the barrel. Each of the first and second inlet channels (1d, 1e) is able to receive product from exactly one of two product reservoirs. For example, the first inlet channel may be enabled to receive a first stem of a dual pump mechanism, and the second inlet channel may be enabled to receive a second stem of the dual pump mechanism. The inlet channels are secured to the stems (4d, 4e) of the dual pump mechanism by an interference fit, as is commonly done in the art.

### Semi-Spiral Insert

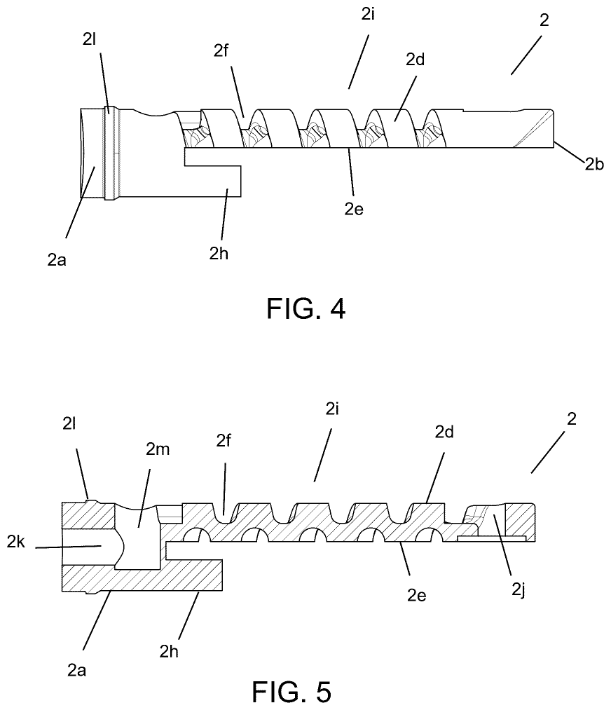

FIGS. 4-7 depict a semi-spiral insert (2) according to a preferred embodiment of the present invention. The semi-spiral insert is an elongated member having a front end (2a) and a rear end (2b). The insert is designed to fit into the actuator housing (1), such that the flow path for conducting the first and second products from the first and second inlet channels (1d, 1e) must pass through the semi-spiral insert. For example, the insert may be designed to fit into the barrel (1f) of the actuator housing (1) through the outlet (1k).

The semi-spiral insert (2) may be cylindrical near the front end, and bifurcated toward the rear end into a relatively shorter lower section (2h), and a relatively longer upper section (2i). The lower section fits snuggly into the lower flow path (1h), and prevents product from flowing toward the outlet (1k) of the barrel. The length of this lower section is such that the lower section stops short of the first inlet channel (1d). The upper section is formed as a semi-cylindrical section, comprising a rounded surface (2d) and a flat surface (2e). The upper semi-cylindrical section (2i) fits snugly into the upper flow path (1i), and extends over the duct (1j) toward the rear of the barrel (1f). A semi-spiral channel (2f) extends along the length of the upper semi-cylindrical section as it passes over the rounded surface and the flat surface of the upper section. One end of the semi-spiral channel is in flow communication with the duct (1j) of the actuator housing (1) through a first passageway (2j). The other end of the semi-spiral channel terminates in a second passageway (2m) that leads to an exit orifice (2k) that is concentric with the outlet (1k) of the actuator housing. Optionally, a snap fit feature, such an annular detent (2l) may be formed near the front end of the semi-spiral insert. The detent is intended to sit in the annular groove (1l) of the wall of the barrel (1f), to hold the insert in place in the actuator housing.

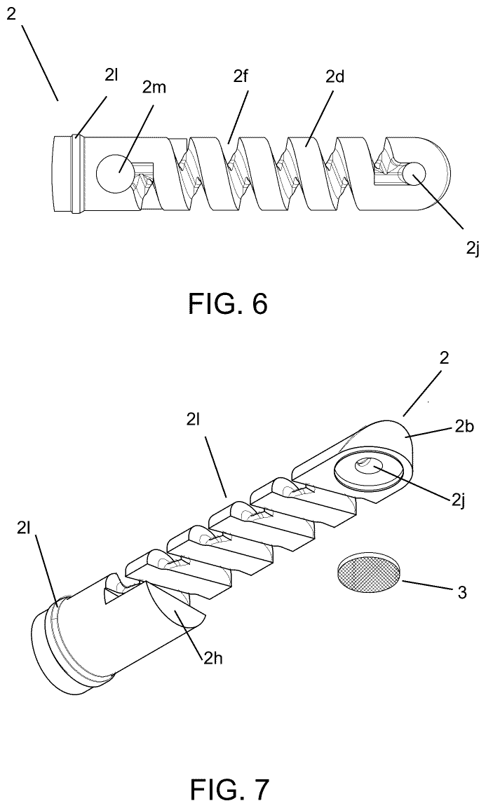

Preferably, the semi-spiral channel (2f) makes at least one complete turn around the upper semi-cylindrical section (2i). More preferably, the semi-spiral channel makes between one and ten complete turns around the upper semi-cylindrical section. For example, FIG. 6 shows a semi-spiral channel that makes 5 complete turns around the upper semi-cylindrical section.

### Mesh Screen

Optionally, but preferably, a mesh screen (3) is positioned in the flow path such that the first and second products must pass through the mesh screen. Preferably, the products pass through the mesh screen before they reach the semi-spiral channel. For example, a mesh screen (3) my be positioned between the duct (1j) of the actuator housing (1) and the first passageway (2j) of the semi-spiral insert (2). The mesh performs a pre-mixing step, and possibly a de-clumping step, before the two products begin moving through the semi-spiral channel. The screen may fashioned of any suitable material, such as polypropylene. Useful mesh sizes may depend on the thickness and viscosity of the two products being mixed. Some useful sizes include 50 holes/square inch to 300 holes/square inch. The more holes in the mesh screen, the more thorough the mixing of the two products.

### Principle of Operation

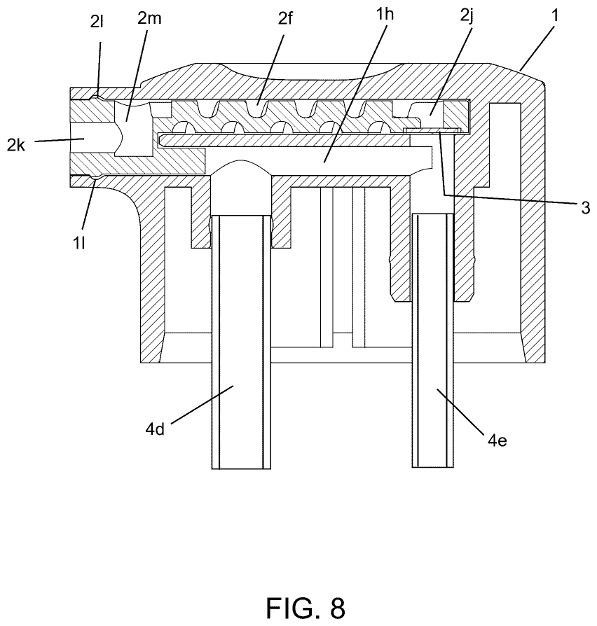

Referring to FIG. 8, in use, two different products flow, each from its own reservoir (not shown), through two stems (4d, 4e), and into the first and second inlet channels (1d, 1e). The two products then enter the lower flow (1h) path, where they come into contact, but do not mix thoroughly. Form there, the two products are directed through duct (1j), mesh screen (3), and first passageway (2j) of the spiral insert (2). From there, the partially mixed products enter into the semi-spiral channel (2f). As both products travel along the semi-spiral channel, turbulent flow caused by differential friction and viscosity causes the products to mix more thoroughly. Significant turbulence occurs as a result of the abrupt changes in the direction of flow that occur when product passes from the rounded surface (2d) to the flat surface (2e) of the semi-spiral insert, and back to the rounded surface. This geometry results in very efficient mixing, more than if the insert were fashioned as fully cylindrical spiral with no abrupt changes in direction. The thoroughly mixed product emerges from the semi-spiral channel (2f) into the second passageway (2m), passes through the exit orifice (2k) of the semi-spiral insert, and continues out of the actuator housing (1).

What is claimed is:

1. An actuating mechanism that comprises:
an actuator housing that comprises:
a first inlet channel that is able to receive a first product from a first product reservoir;
a second inlet channel that is able to receive a second product from a second product reservoir;
an outlet that opens up to the outside of the actuator housing;
a path for conducting the first and second products from the first and second inlet channels to the outlet;
a semi-spiral insert that comprises:
a front end;
a rear end;
a lower section; and
an upper semi-cylindrical section that has a semi-spiral channel that extends along the length of the upper semi-cylindrical section; wherein
the semi-spiral insert is positioned in the actuator housing, such that the path for conducting the first and second products from the first and second inlet channels to the outlet must pass through the semi-spiral channel.

2. The actuating mechanism of claim 1 wherein the semi-spiral channel makes between one and ten complete turns around the upper semi-cylindrical section.

3. The actuating mechanism of claim 2 wherein:
the flow path of the actuator housing is divided into an upper flow path and a lower flow path that are connected through a duct;
the first and second inlet channels open up into the lower flow path; and
the upper semi-cylindrical section is positioned in the upper flow path.

4. The actuating mechanism of claim 2 that further comprises a mesh screen positioned in the flow path such that the first and second products must pass through the mesh screen.

5. The actuating mechanism of claim 4 wherein the first and second products pass through the mesh screen before they reach the semi-spiral channel.

6. The actuating mechanism of claim 5 wherein the mesh screen has from 50 holes/square inch to 300 holes/square inch.

7. The actuating mechanism of claim 1 wherein the lower section of the semi-spiral insert fits snuggly into the lower flow path of the actuator housing, and prevents product from flowing toward the outlet of the actuator housing.

8. The actuating mechanism of claim 1 wherein:
the actuator housing further comprises an annular groove near the outlet of the actuator housing;
the semi-spiral insert further comprises an annular detent near the front end of the semi-spiral insert; and
the annular detent sits in the annular groove, to hold the insert in place in the actuator housing.

9. The actuating mechanism of claim 1 wherein the first inlet channel is enabled to receive a first stem of a dual pump mechanism, and the second inlet channel is enabled to receive a second stem of the dual pump mechanism.
